(19) United States
(12) Patent Application Publication
(10) Pub. No.: US 2020/0111051 A1
(43) Pub. Date: Apr. 9, 2020

(54) ORDER ALLOCATION METHOD AND DEVICE, ELECTRONIC APPARATUS, AND COMPUTER READABLE STORAGE MEDIUM

(71) Applicant: BEIJING XIAODU INFORMATION TECHNOLOGY CO., LTD., Beijing (CN)

(72) Inventors: Ke XIAN, BEIJING (CN); Dairui CUI, BEIJING (CN); Mingquan XU, BEIJING (CN); Shaojian HUANG, BEIJING (CN); Jinqing CHEN, BEIJING (CN); Qiuyuan YANG, BEIJING (CN); Jiajia RAO, BEIJING (CN)

(21) Appl. No.: 16/692,886

(22) Filed: Nov. 22, 2019

Related U.S. Application Data
(63) Continuation of application No. PCT/CN2017/110294, filed on Nov. 9, 2017.

(30) Foreign Application Priority Data
May 25, 2017 (CN) 201710379438.9

(51) Int. Cl. G06Q 10/08; G06Q 10/06

(52) U.S. Cl. CPC G06Q 10/0834; G06Q 10/063112; G06Q 10/0835

(57) ABSTRACT

An order assignment method and apparatus, an electronic device, and a computer-readable storage medium are provided. The method includes: determining a first delivery person corresponding to an order; estimating a delivery efficiency indicator corresponding to delivery performed by the first delivery person for the order; determining that the order is a recallable order if the delivery efficiency indicator is higher than a corresponding preset delivery efficiency indicator threshold, and associating the order with a recallable attribute, and assigning the order to the first delivery person. The first delivery person can conveniently perform a recall operation on the order based on the recallable attribute. Moreover, by first determining whether an order is a recallable order based on the delivery efficiency indicator, the validity of the recall of the order may be ensured.

### CROSS-REFERENCE To RELATED APPLICATION

This application is a continuation application of International Patent Application No. PCT/CN2017/110294, filed on Nov. 9, 2017, which is based on and claims priority to the Chinese Patent Application No. 201710379438.9, filed on May 25, 2017 and entitled “ORDER ALLOCATION METHOD AND DEVICE.” The above-referenced applications are incorporated herein by reference in their entirety.

### TECHNICAL FIELD

This disclosure relates generally to the field of Internet technologies, and more specifically, to an order assignment method and apparatus, an electronic device, and a computer-readable storage medium.

### BACKGROUND

With the development of Internet technologies, Online To Offline (O2O) service, as a novel service mode, has greatly changed people's lifestyles. For example, in term of shopping methods, users can order items they need in an online shopping application without leaving their home. However, while bringing convenience to users, these applications must deal with the issue of efficiently scheduling deliveries for orders. As a result, various logistics scheduling systems have been developed.

Conventionally, after an order is entered into a logistics scheduling system, the scheduling system may assign the order to a specific delivery person based on a specific scheduling policy, and the delivery person may complete the delivery for the order.

### SUMMARY

Based on an existing scheduling policy, after an order is assigned to a specific delivery person, the delivery person generally may need to complete the delivery. However, in an actual delivery process, various factors may cause the delivery person unable or unwilling to complete the delivery of the order. For example, due to a special traffic condition, a low battery state of an electric motorcycle, or delayed dispatch of the order from the merchant due to overbooking, the delivery person may want to recall the order.

According to existing order scheduling policies, to prevent arbitrary recall of orders, when the delivery person requests a recall of the order, the delivery person is required to send the recall application to a staff member of the logistics scheduling platform, and the staff member may determine whether to approve the recall application submitted by the delivery person. Such operations are inconvenient.

In view of the aforementioned deficiencies, this disclosure provides an order assignment method and apparatus, an electronic device, and a computer-readable storage medium, so as to facilitate a recall operation for a delivery person, and to ensure that only justifiable recall operation is granted, thereby preventing arbitrary recall of orders.

A first aspect of this disclosure is directed to an order assignment method, performable by a server. The method may include: determining a first delivery person corresponding to an order; estimating a delivery efficiency indicator corresponding to a delivery of the order performed by the first delivery person; and, if the delivery efficiency indicator is higher than a preset delivery efficiency indicator threshold, associating the order with a recallable attribute and assigning the order to the first delivery person.

In some embodiments, there are a plurality of delivery efficiency indicators, and if the delivery efficiency indicators are higher than preset delivery efficiency indicator thresholds, assigning the order associated with a recallable attribute to a first delivery person may include: assigning the order associated with the recallable attribute to the first delivery person if there is a delivery efficiency indicator higher than a corresponding preset delivery efficiency indicator threshold in the plurality of delivery efficiency indicators.

In some embodiments, the method may further include: reassigning the order to a corresponding second delivery person if a recall request for the order is received from the first delivery person.

In some embodiments, reassigning the order to a corresponding second delivery person may include: obtaining at least one candidate delivery person based on a delivery address of the order; and designating a selected delivery person as the second delivery person if the delivery person selected from the at least one candidate delivery person through an order combining mechanism can accept the order and is different from the first delivery person.

In some embodiments, the method may further includes: obtaining an order group that includes the order if no second delivery person is selected through the order combining mechanism; determining a matching degree between the order group and each of the at least one candidate delivery person; updating the matching degree by reducing a corresponding matching degree between the order group and the first delivery person if the at least one candidate delivery person includes the first delivery person; and assigning the order group to a corresponding second delivery person based on the updated matching degree.

In some embodiments, the recall request may include a recall reason, and reassigning the order to a corresponding second delivery person may include: re-estimating the shipping time and an expected arrival time of the order if the recall reason indicates a long shipping delay; and reassigning the order to a corresponding second delivery person based on the re-estimated shipping time and the re-estimated expected arrival time.

In some embodiments, the method may further include: after re-estimating the shipping time and an expected arrival time of the order, extending the shipping time if an interval between the shipping time and a current time is less than a preset threshold; and extending the expected arrival time if an interval between the expected arrival time and the current time is less than the preset threshold.

In some embodiments, the recall request may include a recall reason, and reassigning the order to a corresponding second delivery person may include: re-estimating the shipping time if the recall reason indicates a long shipping delay; and reassigning the order to a corresponding second delivery person based on the re-estimated shipping time.

In some embodiments, the method may further include: after re-estimating the shipping time of the order, extending the shipping time if an interval between the shipping time and a current time is less than a preset threshold.

In some embodiments, the recall request may include a recall reason, and reassigning the order to a corresponding second delivery person may include: re-estimating an expected arrival time of the order if the recall reason indicates a long shipping delay; and reassigning the order to a corresponding second delivery person based on the re-estimated expected arrival time.

In some embodiments, the method may further include: after re-estimating the expected arrival time of the order, extending the expected arrival time if an interval between the expected arrival time and the current time is less than the preset threshold.

In some embodiments, the method may further include: if the order has been recalled N times, associating the order with a non-recallable attribute, and assigning the order to an (N+1)^{th} delivery person. N is a maximum recall number, and is greater than or equal to 1.

A second aspect of this disclosure is directed to an order assignment apparatus. The apparatus may include: a determination module, an estimation module, and a first assignment module. The determination module may be configured to determine a first delivery person corresponding to an order. The estimation module may be configured to estimate a delivery efficiency indicator corresponding to a delivery of the order performed by the first delivery person. The first assignment module may be configured to, if the delivery efficiency indicator is higher than a preset delivery efficiency indicator threshold, associate the order with a recallable attribute, and assign the order to the first delivery person.

A third aspect of this disclosure is directed to an electronic device. The device may include a processor and a memory. The memory may be configured to store one or more computer instructions. Upon being executed by the processor, the one or more computer instruction may perform the order assignment method according to the first aspect of this disclosure. The electronic device may further include a communications interface for the order assignment apparatus to communicate with other devices or communications networks.

A fourth aspect of this disclosure is directed to a computer-readable storage medium. The computer-readable storage medium is configured to store a computer program. Upon being executed, the computer program may enable a computer to perform the order assignment method according to the first aspect of this disclosure.

With the order assignment method and apparatus, the electronic device, and the computer-readable storage medium according to the embodiments of this disclosure, for a current to-be-assigned order, after a first delivery person for completing the delivery for the order is determined, a delivery efficiency indicator corresponding to the delivery completed by the first delivery person for the order may be estimated, taken into consideration the delivery for the first delivery person's existing orders. If the delivery efficiency indicator is higher than a corresponding delivery efficiency indicator threshold, it is determined that the order is a recallable order, and the order may be associated with a recallable attribute when being assigned to the first delivery person. Thus, if necessary, the first delivery person can conveniently perform a recall operation on the order based on the recallable attribute. Moreover, by first determining whether an order is a recallable order based on the delivery efficiency indicator, the validity of the recall of the order may be ensured.

A fifth aspect of this disclosure is directed to an order assignment method. The method may include: obtaining an order; determining whether the order is a recallable order; and, if the order is determined to be a recallable order, associating the order with a recallable attribute, and assigning the order to a first delivery person.

In some embodiments, determining whether the order is a recallable order may include: determining that the order is a recallable order if attribute information of the order meets a preset recall attribute requirement.

In some embodiments, the attribute information may include at least one of: a user level corresponding to the order, a delivery area corresponding to the order, a service source corresponding to the order, or an expected arrival time corresponding to the order.

In some embodiments, the method may further include: before determining whether the order is a recallable order, determining the first delivery person corresponding to the order. Determining whether the order is a recallable order may include: estimating a delivery efficiency indicator corresponding to a delivery of the order performed by the first delivery person; and determining that the order is a recallable order if the delivery efficiency indicator is higher than a preset delivery efficiency indicator threshold.

A sixth aspect of this disclosure is directed to an order assignment apparatus. The apparatus may include: an obtaining module, an identification module, and an assignment module. The obtaining module may be configured to obtain an order. The identification module may be configured to determine whether the order is a recallable order. The assignment module may be configured to, upon the order being determined by the identification module to be a recallable order, associate the order with a recallable attribute, and assign the order to a first delivery person.

In some embodiments, the identification module may include: a first identification unit, configured to determine that the order is a recallable order if attribute information of the order meets a preset recall attribute requirement.

In some embodiments, the attribute information may include at least one of: a user level corresponding to the order, a delivery area corresponding to the order, a service source corresponding to the order, or an expected arrival time corresponding to the order.

In some embodiments, the apparatus may further include: a determination module, configured to determine the first delivery person corresponding to the order. The identification module may include: a second identification unit, configured to estimate a delivery efficiency indicator corresponding to delivery performed by the first delivery person for the order; and determine that the order is a recallable order if the delivery efficiency indicator is higher than a preset delivery efficiency indicator threshold.

A seventh aspect of this disclosure is directed to an electronic device. The electronic device may include a processor and a memory. The memory may be configured to store one or more computer program instructions. Upon being executed by the processor, the one or more computer instructions may perform the order assignment method according to the fifth aspect of this disclosure. The electronic device may further include a communications interface for the order assignment apparatus to communicate with other devices or communications networks.

An eighth aspect of this disclosure is directed to a computer-readable storage medium. The computer-readable storage medium is configured to store a computer program. Upon being executed, the computer program may enable to computer to perform the order assignment method according to the fifth aspect of this disclosure.

With the order assignment method and apparatus, the electronic device, and the computer-readable storage medium according to the fifth aspect to the eighth aspect of this disclosure, for a to-be-assigned order, before the order is assigned, whether the order is a recallable order (i.e., whether the order is recallable by a delivery person) may be determined. If the order is determined to be a recallable order, the order may be associated with a recallable attribute, and be assigned to a first delivery person. Thus, if necessary, the first delivery person can conveniently perform a recall operation on the order based on the recallable attribute. Moreover, by first determining whether an order is a recallable order, the validity of the recall of the order may be ensured.

### BRIEF DESCRIPTION OF THE DRAWINGS

To describe the technical solutions in embodiments of this disclosure or in the prior art more clearly, the following drawings are used in the description of the embodiments of this disclosure or the prior art. Apparently, the accompanying drawings outlined below are merely some embodiments of this disclosure, and a person of ordinary skill in the art may derive other drawings from these accompanying drawings without creative efforts.

FIG. 1 is a flowchart of Embodiment 1 of an order assignment method according to the embodiments of this disclosure.

FIG. 2 is a flowchart of Embodiment 2 of an order assignment method according to the embodiments of this disclosure.

FIG. 3 is a flowchart of an implementation of step 201 in the embodiment shown in FIG. 2.

FIG. 4 is a flowchart of another implementation of step 201 in the embodiment shown in FIG. 2.

FIG. 5 is a schematic structural diagram of Embodiment 1 of an order assignment apparatus according to the embodiments of this disclosure.

FIG. 6 is a schematic structural diagram of Embodiment 2 of an order assignment apparatus according to the embodiments of this disclosure.

FIG. 7 is a schematic structural diagram of Embodiment 3 of an order assignment apparatus according to the embodiments of this disclosure.

FIG. 8 is a schematic structural diagram of Embodiment 4 of an order assignment apparatus according to the embodiments of this disclosure.

FIG. 9 is a schematic structural diagram of Embodiment 1 of an electronic device according to the embodiments of this disclosure.

FIG. 10 is a flowchart of Embodiment 3 of an order assignment method according to the embodiments of this disclosure.

FIG. 11 is a flowchart of Embodiment 4 of an order assignment method according to the embodiments of this disclosure.

FIG. 12 is a schematic structural diagram of Embodiment 5 of an order assignment apparatus according to the embodiments of this disclosure.

FIG. 13 is a schematic structural diagram of Embodiment 6 of an order assignment apparatus according to the embodiments of this disclosure.

FIG. 14 is a schematic structural diagram of Embodiment 2 of an electronic device according to the embodiments of this disclosure.

### DETAIL DESCRIPTION OF THE EMBODIMENTS

To make the objectives, technical solutions, and advantages of embodiments of this disclosure clearer, the following gives a clear description of technical solutions in the embodiments of this disclosure in full with reference to accompanying drawings of this disclosure. Apparently, the described embodiments are some but not all of the embodiments of this disclosure. All other embodiments derived by a person of ordinary skill in the art based on the embodiments in this disclosure without creative efforts shall fall within the protection scope of this disclosure.

The terms used in the embodiments of this disclosure are intended merely for describing specific embodiments rather than limiting this disclosure. The singular forms “a”, “the”, and “this” used in the embodiments of this disclosure and the claims attached hereto are intended to include plural forms thereof. Unless otherwise expressly indicated in the context, “a plurality of” generally indicates at least two, but without excluding indication of at least one.

It should be understood that, the term “and/or” used herein merely describes an association relationship between associated objects, indicating that there may be three relationships. For example, A and/or B may indicate three cases: only A exists, both A and B exist, and only B exists. In addition, the character “/” used herein generally indicates an “or” relationship between associated objects.

It should be understood that, although the terms such as “first”, “second”, and “third” may be used to describe an object in the embodiments of this disclosure, the object shall not be limited by these terms. The terms are merely used to distinguish the objects from each other. For example, a first object may also be referred to as a second object without departing from the scope of the embodiments of this disclosure. Similarly, a second object may also be referred to as a first object.

Depending on the context, the words “in case” and “if” used herein may be interpreted as “while” or “when” or “in response to determining” or “in response to detecting”. Similarly, depending on the context, the phrase “if it is determined that” or “if it is detected that (a condition or event stated)” may be interpreted as “when it is determined that” or “in response to determining that” or “when it is detected that (a condition or event stated)” or “in response to detecting that (a condition or event stated)”.

It should also be noted that the terms “including”, “comprising” or any other variations thereof are intended to encompass a non-exclusive inclusion, so that an item or system including a series of elements includes not only those elements but also other elements that are not specifically listed or inherent elements of the item or system. Except as otherwise limited, an element defined by the phrase “including a . . . ” does not exclude existence of additional identical elements in the item or system that includes the element.

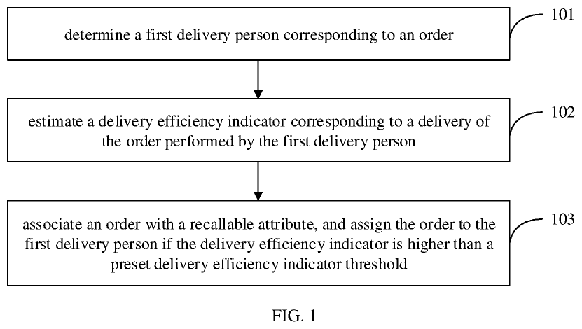

FIG. 1 is a flowchart of Embodiment 1 of an order assignment method according to the embodiments of this disclosure. The order assignment method provided in this embodiment may be implemented by an order assignment apparatus, which may be implemented as software or a combination of software and hardware, and may be integrated in a device on a logistics scheduling platform end such as a server. As shown in FIG. 1, the method may include the following steps.

In step 101. a first delivery person corresponding to an order may be determined.

When receiving an order that requires a delivery, the server may have a plurality of specific scheduling policies for assigning a corresponding delivery person to the order.

Specifically, in the first example, the server may assign a corresponding first delivery person to an order immediately upon receiving the order. In the second example, the server may preset a scheduling period such as five minutes, and schedule a plurality of orders that are received within one scheduling period, including the to-be-assigned order, as a whole, and assign a corresponding delivery person to each of the orders.

Optionally, when the first delivery person is assigned to a received order using the method described the first example, the first delivery person assigned for the order may be determined by using the following order combining mechanism. First, based on a delivery address of the order, a delivery area that covers the order may be determined. Second, one or more delivery person in the delivery area may be obtained based on location information of the delivery person. Third, a matching degree between the order and an existing order of each delivery person may be determined. Fourth, using a delivery person corresponding to the highest matching degree as the first delivery person, and the order may be assigned to the first delivery person.

The location information of each delivery person may be location information reported by each delivery person, or may be delivery area identification information that is assigned to each delivery person in initial registration of each delivery person. An existing order of the delivery person may refer to an order that has been assigned to, but has not been completed by, the delivery person. The matching degree may be determined by, for example, determining a distance between a delivery address of the order and a delivery address of an existing order of a delivery person. In this case, a criterion for evaluating the matching degree may be the distance between the delivery addresses. The criterion for evaluating the matching degree may further include other parameters, such as an interval between expected arrival times. When a plurality of measurement parameters are included, a corresponding matching degree may be determined based on a weighted sum of the plurality of measurement parameters.

When the first delivery person is assigned to the received order using the method described in the second example, the first delivery person assigned to the order may be determined by using the order combining mechanism and the following grouping mechanism.

First, for a plurality of orders received in a current scheduling period, assuming that the plurality of orders correspond to the same delivery area, the orders may be grouped based on a similarity between the orders. For each order group, a matching degree between the order group and each delivery person (i.e., between the order group and an existing order of each delivery person) may be determined. Second, a plurality of matching degree combinations may be determined, and one matching degree combination that results in an optimal overall matching may be selected. Third, a delivery person corresponding to each order group may be determined based on a correspondence represented by the selected matching degree combination between the order group and the delivery person. The first delivery person corresponding to the order is a delivery person corresponding to an order group that includes the order.

A similarity between every two orders may be determined based on similarity measurement parameters such as a distance between delivery addresses. Grouping orders based on a similarity between orders may include: with respect to one order, based on similarities between the order and other orders, grouping orders that have a similarity greater than a specific threshold into one group.

In each matching degree combination, an order group may have a one-to-one correspondence with a delivery person. That is, in a same matching degree combination, one order group may correspond to only one delivery person. That is because one order group may only be assigned to one delivery person for delivery.

In step 102, a delivery efficiency indicator corresponding to a delivery of the order performed by the first delivery person may be estimated.

In step 103, the order may be associated with a recallable attribute and be assigned to the first delivery person if the delivery efficiency indicator is higher than a preset delivery efficiency indicator threshold.

In this embodiment, to facilitate an order recall operation of a delivery person while maintaining stability of a scheduling system, and avoiding adverse impact caused by an arbitrary order recall operation of a delivery person to the stability and scheduling efficiency of the scheduling system, whether an order can be recalled may first be determined. Not all orders can be recalled.

In some embodiments, whether an order is a recallable order may be determined based on a delivery efficiency indicator corresponding to a delivery of the order completed by a first delivery person corresponding to the order. The delivery efficiency indicator may be a preset indicator that affects the delivery efficiency of the corresponding delivery person. The delivery efficiency indicator may include one or more of indicators including, but not limited to, an estimated completion time, an estimated delivery distance, and a quantity of existing orders of the first delivery person. Specifically, the estimated completion time and the estimated delivery distance may refer to a time and a distance, respectively, required to complete the delivery for the order currently assigned to the first delivery person, and the delivery may be performed by the first delivery person when he or she delivers, based on a specific delivery policy, all orders that require delivery, including the order currently assigned to the first delivery person.

In one example, it may be assumed that the order currently assigned to the first delivery person is an order A. Before the order A is assigned to the first delivery person, the first delivery person may have existing uncompleted orders: orders B and C. Based on a preset delivery policy, a delivery sequence of these orders may be: order B, followed by order A, and followed by order C. Based on a current location of the first delivery person and delivery addresses corresponding to the order B and the order A, a map navigation application may be invoked, a delivery path may be planned, and a travel distance required to complete the delivery for order A may be estimated. In addition, a time required to complete the delivery for order A may be estimated based on a preset travel speed. When estimating the delivery distance and the completion time, the estimation may be performed based on preset delivery parameters including, but not limited to, the travel speed of the delivery person, a corresponding distance between adjacent orders on the delivery path, and a user wait time corresponding to each order.

For example, the delivery efficiency indicator corresponding to a delivery of the order (e.g., order A) performed by the first delivery person may be determined by: planning a delivery path corresponding to the order (e.g., order A) and the existing uncompleted orders (e.g., order B and order C) of the first delivery person; and, based on a delivery sequence indicated by the delivery path for the orders and the preset delivery parameters, estimating the delivery efficiency indicator corresponding to the order (e.g., order A).

After the delivery efficiency indicator corresponding to the delivery performed by the first delivery person for the order is estimated, if the delivery efficiency indicator is higher than a corresponding preset delivery efficiency indicator threshold, the order may be determined to be a recallable order, and the order may be associated with a recallable attribute and be assigned to the first delivery person. When there are a plurality of delivery efficiency indicators, if one of the plurality of delivery efficiency indicators is higher than the corresponding preset delivery efficiency indicator threshold, the order may be determined to be a recallable order.

In actual application, if the first delivery person receives an order associated with the recallable attribute, the order may be associated with a recallable operation option on a client of the first delivery person. Thus, when the first delivery person performs an operation on the order, displayed operation options may include the recallable operation option, so that, if necessary, the first delivery person may perform a recall operation on the order.

In this embodiment, for a to-be-assigned order, after a first delivery person for delivering the order is determined, a delivery efficiency indicator corresponding to the delivery of the order, along with delivering existing orders, by the first delivery person may be estimated. If the delivery efficiency indicator is higher than a corresponding indicator threshold, the order may be determined to be a recallable order, and the order may be associated with a recallable attribute when being assigned to the first delivery person. Thus, if necessary, the first delivery person can conveniently perform a recall operation on the order based on the recallable attribute. Moreover, by first determining whether an order is a recallable order based on the delivery efficiency indicator, the validity of the recall of the order may be ensured.

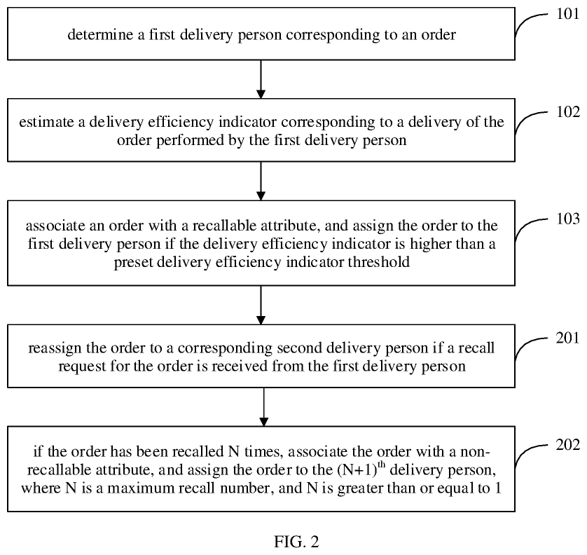

FIG. 2 is a flowchart of Embodiment 2 of an order assignment method according to the embodiments of this disclosure. As shown in FIG. 2, after step 103, the method may further include the following steps.

In step 201, the order may be reassigned to a corresponding second delivery person if a recall request for the order is received from the first delivery person.

In this embodiment, based on the recallable attribute associated with the order, the first delivery person can conveniently perform a recall operation on the order when encountering a special situation. The special situation may include: the first delivery person has a relatively large number of existing orders, and cannot deliver the order in time. The special situation may also include: the first delivery person encounters an electric motorcycle failure or a special traffic condition during the delivery, or the dispatch of the order from the merchant is delayed due to overbooking, etc.

When the first delivery person performs a recall operation on the order on the client, the client may send a recall request to the server to inform the server that the first delivery person performs the recall operation on the order. In this case, the server needs to reassign the order to another delivery person, referred to as a second delivery person. Generally, the second delivery person may be different from the first delivery person, but the scenario that the reselected second delivery person is still the original first delivery person is not excluded in this disclosure. The process of determining the second delivery person may be similar to the process of determining the first delivery person, and is described in a subsequent embodiment.

In step 202, if the order has been recalled N times, the order may be associated with a non-recallable attribute, and may be assigned to an (N+1)^{th} delivery person. N is a maximum recall number, and is greater than or equal to 1.

In this embodiment, to avoid a problem that an order fails to be delivered in time due to repeated recalls, the maximum recall number N may be set. For example, the number may be set to 3. If an order reaches the maximum recall number, an (N+1)^{th} delivery person to whom the order is subsequently reassigned can no longer perform a recall operation on the order. That is, the order is associated with the non-recallable attribute and is assigned to the (N+1)^{th} delivery person, and the delivery person cannot perform a recall operation on the order.

It may be understood that, the recall request may include an order identifier, so that the server may count the number of recalls for the corresponding order.

In some embodiments, the server may preferentially schedule a recalled order. More specific, when scheduling orders, the recalled order may receive priority over initially received to-be-assigned orders, and the recalled order may be preferentially assigned to a delivery person. Therefore, the server may mark the order corresponding to the recall request as a recalled order, so that the server can identify the recalled order in a plurality of orders that need to be scheduled, and schedule the recalled order with higher priority.

In this embodiment, whether an order is a recallable order may first be determined. If the order is determined to be a recallable order, the order may be associated with a recallable attribute and sent to the delivery person, so that, if necessary, the delivery person can conveniently perform a recall operation on the order. The implementation is simple and convenient. Moreover, a maximum recall number may be set, so that adverse impact to user experience that may be caused by repeated recalls and delayed delivery of the order may be avoided.

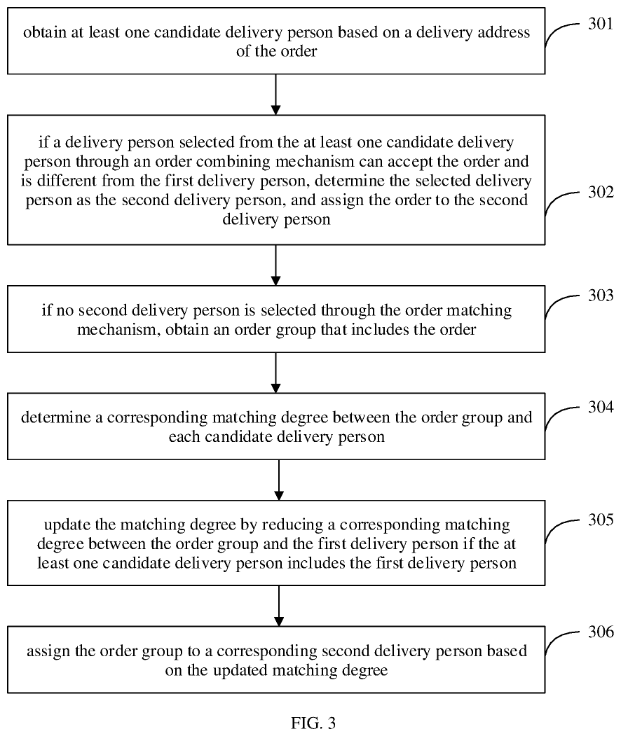

FIG. 3 is a flowchart of an implementation of step 201 in the embodiment shown in FIG. 2. As shown in FIG. 3, the implementation may include the following steps.

In step 301, at least one candidate delivery person may be obtained based on a delivery address of the order.

After a recall operation on a recallable order is performed by the first delivery person, the recalled order may be considered as a new order, and may be reassigned to another delivery person.

Specifically, a delivery area that covers the recalled order may first be determined based on the delivery address of the recalled order, and then each delivery person in the delivery area may be obtained as a candidate delivery person based on location information of the delivery person. The at least one candidate delivery person may include the first delivery person to which the recalled order is originally assigned, or may not include the first delivery person to avoid the recalled order being reassigned to the same delivery person.

In step 302, if a delivery person selected from the at least one candidate delivery person through an order combining mechanism can accept the order and is different from the first delivery person, the selected delivery person may be designated as the second delivery person, and be assigned the order.

As described in the foregoing embodiment shown in FIG. 1, the order combining mechanism may include: considering the recalled order as an independent to-be-scheduled order, and determining, based on a matching degree between the recalled order and each candidate delivery person, a corresponding second delivery person for the order. To be precise, the matching degree between the recalled order and each candidate delivery person may be a matching degree between the recalled order and an existing order of each candidate delivery person. The description in the foregoing embodiment shown in FIG. 1 may be referred to for specific procedures of determining the matching degree and the process of selecting a delivery person based on the matching degree, which are not repeatedly described herein for the sake of conciseness.

In this embodiment, when the at least one candidate delivery person includes the first delivery person, and the delivery person selected through the order combining mechanism is the first delivery person, the recalled order may not be assigned to the first delivery person again.

Instead, a subsequent grouping mechanism may be performed to selected a second delivery person to assign the recalled order to. Conversely, if the delivery person selected through the order combining mechanism is not the first delivery person, the selected delivery person may be designated as the second delivery person, and may be assigned the recalled order.

To prevent the server from reassigning the recalled order to the original first delivery person, the recall request received from the first delivery person may further include an identifier of the first delivery person, so that the server may identify the delivery person who recalls the order, and avoid assigning the order to the same delivery person again.

If the number of recalls has not reached the maximum recall number, the recalled order associated with the recallable attribute may be assigned to the second delivery person. Conversely, if the number of recalls has reached the maximum recall number, the recalled order may be associated with a non-recallable attribute, and be assigned to the second delivery person.

In step 303, if no second delivery person is selected through the order combining mechanism, an order group that includes the order may be obtained.

In step 304, a corresponding matching degree between the order group and each candidate delivery person may be determined.

In this embodiment, if no second delivery person is selected through the order combining mechanism, the second delivery person for the order may be determined through a grouping mechanism.

As described in the foregoing embodiment shown in FIG. 1, a plurality of to-be-assigned orders in the server may be first grouped based on a similarity between the to-be-assigned orders to obtain an order group that includes the recalled order. Further, a corresponding matching degree between the order group and each candidate delivery person (i.e., a matching degree between the order group and an existing order of each candidate delivery person) may be determined.

In step 305, the matching degree may be updated by reducing a corresponding matching degree between the order group and the first delivery person if the at least one candidate delivery person includes the first delivery person.

It is possible that the at least one candidate delivery person may include the first delivery person to whom the recalled order is originally assigned. If the at least one candidate delivery person does include the first delivery person, after the matching degree between the recalled order and the existing order of each candidate delivery person is determined, the matching degree corresponding to the first delivery person may be reduced to decrease a probability of the first delivery person being assigned the order group that includes the recalled order.

In step 306, the order group may be assigned to a corresponding second delivery person based on the updated matching degree.

In some embodiments, a candidate delivery person corresponding to the highest matching degree may be selected as the second delivery person based on the corresponding matching degree between each candidate delivery person and the order group that includes the recalled order. In this case, since the matching degree corresponding to the first delivery person has been reduced, the first delivery person will not become the second delivery person to whom the recalled order will be reassigned.

In some embodiments, when the server performs group scheduling on the recalled order, the order groups obtained by grouping may include other order groups in addition to the order group that includes the recalled order. As described in the embodiment shown in FIG. 1, in this case, the matching degree between each of the obtained order groups and each candidate delivery person may be determined respectively. A matching degree combination that accomplishes an optimal overall matching may be selected, and the delivery person corresponding to the order group that includes the recalled order may be designated as the second delivery person based on a correspondence represented by the selected matching degree combination between the order group and the delivery person.

In this embodiment, when the recalled order is reassigned to a delivery person, the recalled order can be prevented from being repeatedly assigned to the delivery person who has performed the recall operation, and the probability that the delivery person to whom the recalled order is reassigned can complete the delivery of the order may be increased.

FIG. 4 is a flowchart of another implementation of step 201 in the embodiment shown in FIG. 2. As shown in FIG. 4, the implementation may include the following steps.

In step 401, a shipping time and/or an expected arrival time corresponding to the order may be re-estimated if a recall reason included in the received recall request indicates a long shipping delay.

In step 402, the shipping time may be extended if an interval between the shipping time and a current time is less than a preset threshold, and/or the expected arrival time may be extended if an interval between the expected arrival time and the current time is less than the preset threshold.

In step 403, the order may be reassigned to a corresponding second delivery person based on the re-estimated shipping time and/or the re-estimated expected arrival time.

Based on the description in the foregoing embodiment, the order associated with the recallable attribute may be associated with a recall operation option on the client of the first delivery person, so that the first delivery person may perform a recall operation on the order by clicking the recall operation option.

In addition, the order may be further associated with recall reason options on the client of the first delivery person. When performing an operation on the recall operation option, the first delivery person may provide the recall reason to the server by selecting a recall reason option. For example, recall reason options may include a vehicle failure, a special traffic condition, having an excessive quantity of orders, and a long shipping delay.

The recall reasons exemplified above may include a reason associated with the delivery person, such as having an excessive quantity of orders, an uncontrollable factor, such as a vehicle failure or a special traffic condition, and a reason associated with the shipper, such as a long shipping delay.

When the recall is caused by a reason associated with the first delivery person or an uncontrollable factor, the server may reassign the recalled order with reference to the description of the foregoing embodiment. When the recall is caused by a long shipping delay, before the recalled order is reassigned as described in the foregoing embodiment, the following pre-processing process may be conducted.

Estimated results of the shipping time and/or the expected arrival time may be used in the process of assigning the first delivery person to the order, in the process of determining the matching degree between the order and the first delivery person, or in the process of grouping the orders. A long shipping delay, however, may cause the estimated shipping time inapplicable, and further cause the estimated expected arrival time inapplicable because the estimation of the expected arrival time is generally affected by the estimated result of the shipping time. On the other hand, for recalls caused by other reasons, the estimated result of the shipping time, and the estimated result of the expected arrival time are not affected.

Therefore, when the first delivery person performs a recall operation due to a long shipping delay, it is necessary to re-estimate the shipping time and/or the expected arrival time corresponding to the order. The shipping time may be estimated based on a preset policy. For example, for every recall, a previously estimated shipping time may be extended by a fixed increment of time. The expected arrival time may be estimated based on the re-estimated shipping time and a relationship between the expected arrival time and the shipping time.

It should be noted that if an interval between the re-estimated shipping time and the current time is less than a preset threshold, it indicates that the re-estimated shipping time is not appropriate, and the shipping time needs to be extended, for example, by a fixed increment of time. Similarly, if an interval between the expected arrival time and the current time is less than the preset threshold, the expected arrival time also needs to be extended.

Further, the order may be reassigned to a corresponding second delivery person based on the re-estimated shipping time and/or the re-estimated expected arrival time. Specifically, the re-estimated shipping time and/or the re-estimated expected arrival time may be applied to the foregoing processes of determining the matching degree and determining the similarity between order groups.

In this embodiment, a recall reason feedback function may also be provided on the client of the delivery person, so that the server can be accurately informed the recall reason of the delivery person, and perform pertinent reassignment of the order based on the recall reason.

Order assignment apparatuses in one or more embodiments of this disclosure are described in detail below. The order assignment apparatuses may be implemented in infrastructure of a server or in architecture of a server during client-server interaction. A person skilled in the art may understand that these order assignment apparatuses can all be constructed using commercially available hardware components as taught by this solution.

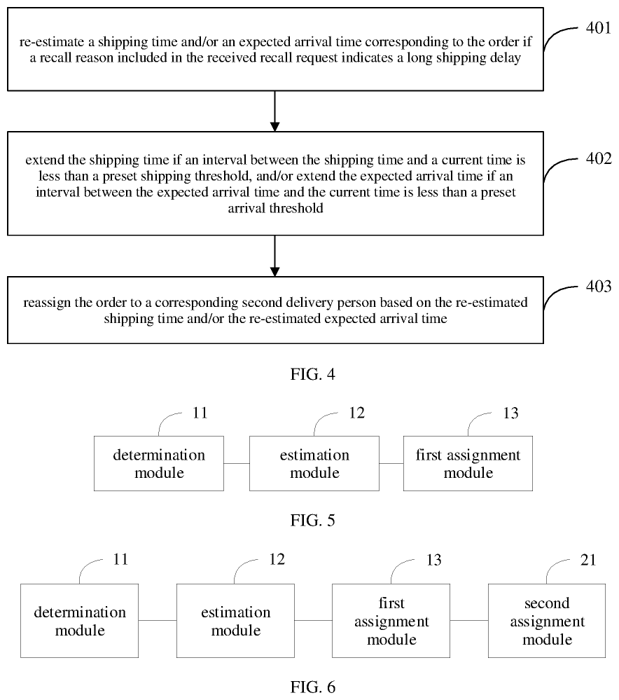

FIG. 5 is a schematic structural diagram of Embodiment 1 of an order assignment apparatus according to the embodiments of this disclosure. As shown in FIG. 5, the apparatus may include a determination module 11, an estimation module 12, and a first assignment module 13.

The determination module 11 may be configured to determine a first delivery person corresponding to an order.

The estimation module 12 may be configured to estimate a delivery efficiency indicator corresponding to a delivery of the order performed by the first delivery person.

The first assignment module 13 may be configured to associate the order with a recallable attribute, and assign the order to the first delivery person if the delivery efficiency indicator is higher than a preset delivery efficiency indicator threshold.

In some embodiments, there may be a plurality of delivery efficiency indicators, and the first assignment module 13 may be specifically configured to assign the order associated with the recallable attribute to the first delivery person if one of the plurality of delivery efficiency indicators is higher than a corresponding preset delivery efficiency indicator threshold.

The apparatus shown in FIG. 5 can perform the method in the embodiment shown in FIG. 1. Related description in the embodiment shown in FIG. 1 may be referred to for the part not described in detail in this embodiment, and for the implementation process and technical effects of the technical solution, which are not repeatedly described herein for the sake of conciseness.

FIG. 6 is a schematic structural diagram of Embodiment 2 of an order assignment apparatus according to the embodiments of this disclosure. As shown in FIG. 6, on the basis of the embodiment shown in FIG. 5, the apparatus may further include a second assignment module 21.

The second assignment module 21 may be configured to reassign the order to a corresponding second delivery person if a recall request for the order is received from the first delivery person.

The second assignment module 21 may be further configured to, if the order has been recalled N times, associate the order with a non-recallable attribute, and assign the order to an (N+1)^{th} delivery person. N is a maximum recall number, and is greater than or equal to 1.

The apparatus shown in FIG. 6 can perform the method in the embodiment shown in FIG. 2. Related description in the embodiment shown in FIG. 2 may be referred to for the part not described in detail in this embodiment, and for the implementation process and technical effects of the technical solution, which are not repeatedly described herein for the sake of conciseness.

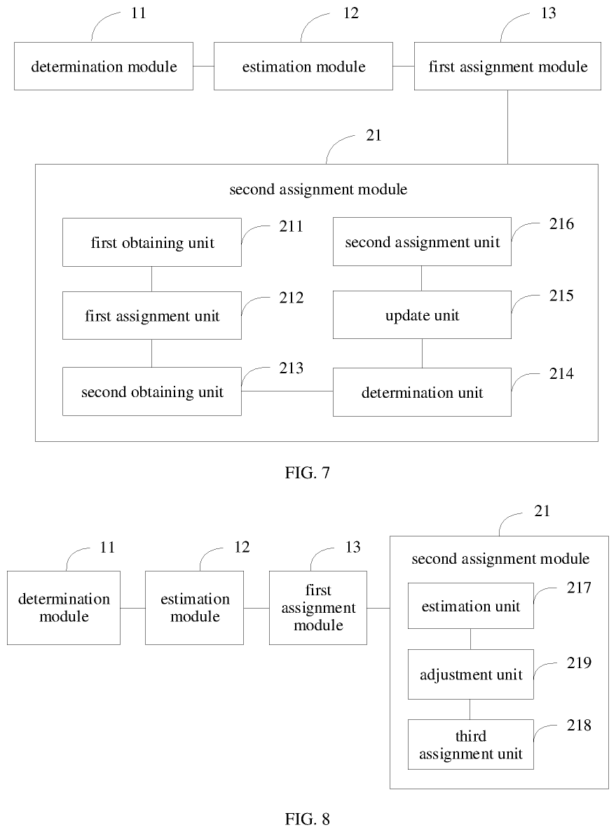

FIG. 7 is a schematic structural diagram of Embodiment 3 of an order assignment apparatus according to the embodiments of this disclosure. As shown in FIG. 7, on the basis of the embodiment shown in FIG. 6, the second assignment module 21 may include: a first obtaining unit 211, a first assignment unit 212, a second obtaining unit 213, a determination unit 214, an update unit 215, and a second assignment unit 216.

The first obtaining unit 211 may be configured to obtain at least one candidate delivery person based on a delivery address of the order.

The first assignment unit 212 may be configured to designate, if a delivery person selected from the at least one candidate delivery person through an order combining mechanism can accept the order and is different from the first delivery person, the selected delivery person as the second delivery person.

The second obtaining unit 213 may be configured to obtain an order group that includes the order if no second delivery person is selected by the first assignment unit 212 through the order combining mechanism.

The determination unit 214 may be configured to determine a matching degree between the order group and each of the at least one candidate delivery person.

The update unit 215 may be configured to update the matching degree by reducing a corresponding matching degree between the order group and the first delivery person if the at least one candidate delivery person includes the first delivery person.

The second assignment unit 216 may be configured to assign the order group to a corresponding second delivery person based on the updated matching degree.

The apparatus shown in FIG. 7 can perform the method in the embodiment shown in FIG. 3. Related description in the embodiment shown in FIG. 3 may be referred to for the part not described in detail in this embodiment, and for the implementation process and technical effects of the technical solution, which are not repeatedly described herein for the sake of conciseness.

FIG. 8 is a schematic structural diagram of Embodiment 4 of an order assignment apparatus according to the embodiments of this disclosure. As shown in FIG. 8, on the basis of the embodiment shown in FIG. 6 or FIG. 7, the recall request may include a recall reason, and the second assignment module 21 may further includes: an estimation unit 217 and a third assignment unit 218.

The estimation unit 217 may be configured to re-estimate a shipping time and/or an expected arrival time of the order if the recall reason indicates a long shipping delay.

The third assignment unit 218 may be configured to reassign the order to a corresponding second delivery person based on the re-estimated shipping time and/or the re-estimated expected arrival time.

The second assignment module 21 may further include an adjustment unit 219.

The adjustment unit 219 may be configured to extend the shipping time if an interval between the shipping time and a current time is less than a preset threshold, and/or to extend the expected arrival time if an interval between the expected arrival time and the current time is less than the preset threshold.

In some embodiments, the estimation unit 217 may be configured to re-estimate a shipping time and an expected arrival time of the order if the recall reason indicates a long shipping delay.

The third assignment unit 218 may be configured to reassign the order to a corresponding second delivery person based on the re-estimated shipping time and the re-estimated expected arrival time.

The adjustment unit 219 may be configured to extend the shipping time if an interval between the shipping time and a current time is less than a preset threshold, and to extend the expected arrival time if an interval between the expected arrival time and the current time is less than the preset threshold.

In some embodiments, the estimation unit 217 may be configured to re-estimate a shipping time of the order if the recall reason indicates a long shipping delay.

The third assignment unit 218 may be configured to reassign the order to a corresponding second delivery person based on the re-estimated shipping time.

The adjustment unit 219 may be configured to extend the shipping time if an interval between the shipping time and a current time is less than a preset threshold.

In some embodiments, the estimation unit 217 may be configured to re-estimate an expected arrival time of the order if the recall reason indicates a long shipping delay.

The third assignment unit 218 may be configured to reassign the order to a corresponding second delivery person based on the re-estimated expected arrival time.

The adjustment unit 219 may be configured to extend the expected arrival time if an interval between the expected arrival time and a current time is less than a preset threshold.

The apparatus shown in FIG. 8 can perform the method in the embodiment shown in FIG. 4. Related description in the embodiment shown in FIG. 4 may be referred to for the part not described in detail in this embodiment, and for the implementation process and technical effects of the technical solution, which are not repeatedly described herein for the sake of conciseness.

The apparatus embodiments described above are merely examples. The units described as discrete parts may be physically separated or not, and parts displayed as units may be physical units or not, may be located in one place or distributed on a plurality of network units. Some or all of the modules may be selected according to actual needs to achieve the objectives of the solution of this embodiment. A person of ordinary skill in the art can understand and implement the solution without creative efforts.

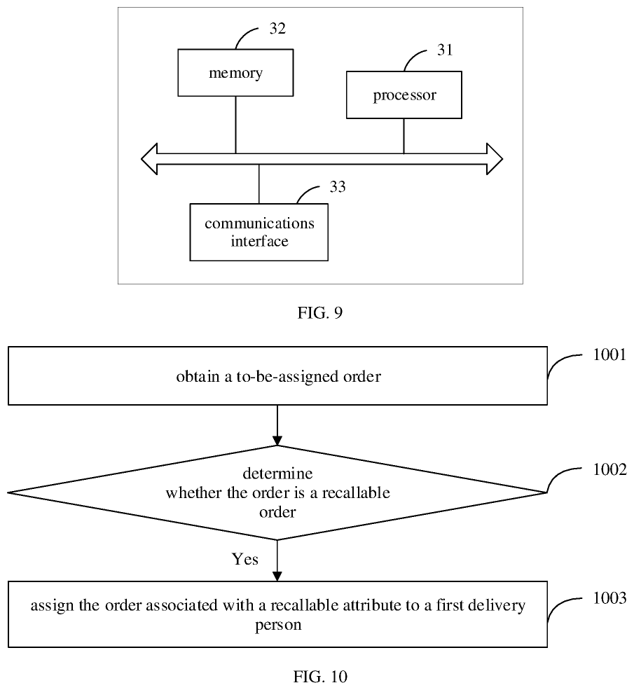

The internal functions and structure of the order assignment apparatus have been described above. In a possible design, an electronic device may be provided. The electronic device may be a server. As shown in FIG. 9, the electronic device may include a processor 31 and a memory 32. The memory 32 may be configured to store a program that enables the electronic device to perform the order assignment method according to any of the foregoing embodiments, and the processor 31 may be configured to execute the program stored in the memory 32.

The program may include one or more computer instructions. Upon being executed by the processor 31, the one or more computer instructions can perform the following steps. First, a first delivery person corresponding to an order may be determined; second, a delivery efficiency indicator corresponding to a delivery of the order performed by the first delivery person may be estimated; third, if the delivery efficiency indicator is higher than a preset delivery efficiency indicator threshold, the order may be associated with a recallable attribute and be assigned to the first delivery person.

In some embodiments, the processor 31 may be further configured to perform all or some of the steps in the foregoing method embodiments.

The structure of the order assignment apparatus may further include a communications interface 33 for the electronic device to communicate with other devices or communications networks.

This disclosure further provides a computer-readable storage medium. The computer-readable storage medium may be configured to store a computer software instruction and may include a program for performing the order assignment methods described in the embodiments shown in FIG. 1 to FIG. 4.

FIG. 10 is a flowchart of Embodiment 3 of an order assignment method according to the embodiments of this disclosure. The order assignment method provided in this embodiment may be implemented by an order assignment apparatus, which may be implemented as software or a combination of software and hardware, and may be integrated in a device on a logistics scheduling platform end such as a server. As shown in FIG. 10, the method may include the following steps.

In step 1001, a to-be-assigned order may be obtained.

Generally, numerous to-be-assigned orders may be continually triggered by users and enter the server. In one embodiment, the server may assign a corresponding first delivery person to a to-be-assigned order immediately upon receiving the order. In another embodiment, the server may preset a scheduling period such as five minutes, and schedule a plurality of orders that are received within one scheduling period, including the obtained to-be-assigned order, as a whole, and assign a corresponding delivery person to each of the orders. In this case, the to-be-assigned order in step 1001 may be any of the plurality of orders.

In step 1002, whether the order is a recallable order may be determined. If the order is determined to be a recallable order, step 1003 may be performed. If the order is determined to be a non-recallable order, the order may be associated with a non-recallable attribute, and be assigned to the first delivery person.

In step 1003, the order may be associated with a recallable attribute and be assigned to a first delivery person.

In this embodiment, to facilitate an order recall operation of a delivery person while maintaining stability of a scheduling system, and avoiding adverse impact caused by an arbitrary order recall operation of a delivery person to the stability and scheduling efficiency of the scheduling system, whether an order can be recalled may first be determined. Not all orders can be recalled.

In some embodiments, whether the to-be-assigned order is a recallable order may be determined based on attribute information of the order. More specifically, an order may be determined to be a recallable order if the attribute information of the order meets a preset recall attribute requirement. In some embodiments, the first delivery person corresponding to the order may first be determined, and then a delivery efficiency indicator corresponding to a delivery of the order performed by the first delivery person may be estimated, and whether the to-be-assigned order is a recallable order may be determined based on the delivery efficiency indicator. More specifically, the order may be determined to be a recallable order if the delivery efficiency indicator is higher than a preset delivery efficiency indicator threshold.

In determining the recallable order based on the attribute information of the order, the attribute information may include at least one of: a user level corresponding to the order, a delivery area corresponding to the order, a service source corresponding to the order, or an expected arrival time corresponding to the order.

The user level may refer to a level of the user placed the order. The server may determine the level of the user based on factors such as a delivery address corresponding to the user, and the quantity of orders placed by the user within a specified period of time. The delivery area may be determined based on the delivery address corresponding to the order. The service source may refer to a service on the server accessed by the user when placing the order. The expected arrival time is a time when the order is expected to be delivered to the corresponding user, which may be estimated by the server based on a preset estimation algorithm.

Based on the attribute information and a recall attribute requirement corresponding to each of the attribute information, determining whether an order is a recallable order may include the following criteria. If the user level corresponding to the order is lower than a preset level, the order may be determined to be a recallable order. If the expected arrival time corresponding to the order is later than a preset time, the order may be determined to be a recallable order. If the service source corresponding to the order is one of preset service sources that allow a recall of the order, the order may be determined to be a recallable order. If the delivery area corresponding to the order is one of preset delivery areas that allow a recall of the order, the order may be determined to be a recallable order.

In determining the recallable order based on the delivery efficiency indicator of the order, the delivery efficiency indicator may include one or more of indicators such as an estimated completion time, an estimated delivery distance, and a quantity of existing orders of the first delivery person. Relevant description in the embodiment shown in FIG. 1 may be referred to for the process of determining the delivery efficiency indicator and the process of determining the first delivery person, the details of which are not repeatedly described herein for the sake of conciseness.

In this embodiment, before a to-be-assigned order is assigned, whether the order is a recallable order may be determined. That is, whether the order is recallable by a delivery person may be determined. If the order is determined to be a recallable order, the order may be associated with a recallable attribute and be assigned to a first delivery person. Thus, if necessary, the first delivery person can conveniently perform a recall operation on the order based on the recallable attribute. Moreover, by first determining whether an order is a recallable order, the validity of the recall of the order may be ensured.

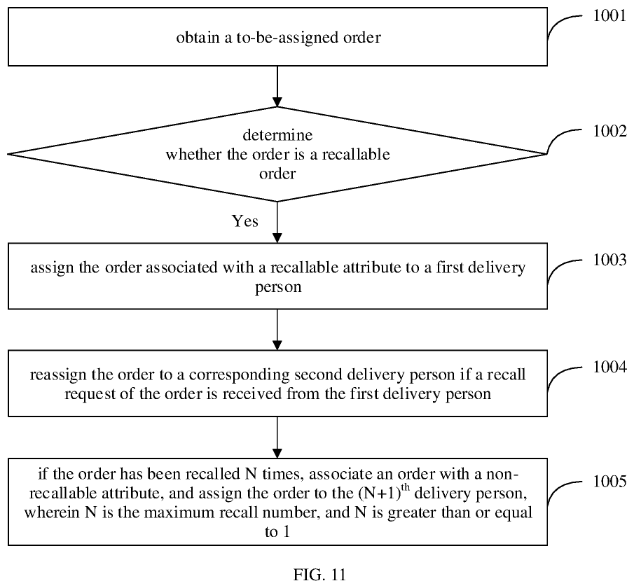

FIG. 11 is a flowchart of Embodiment 4 of an order assignment method according to the embodiments of this disclosure. As shown in FIG. 11, on the basis of the embodiment shown in FIG. 10, after step 1003, the method may further include the following steps.

In step 1004, the order may be reassigned to a corresponding second delivery person if a recall request for the order is received from the first delivery person.

In step 1005, if the order has been recalled N times, the order may be associated with a non-recallable attribute and be assigned to an (N+1)^{th} delivery person. N is a maximum recall number, and is greater than or equal to 1.

Relevant description in the foregoing embodiments shown in FIG. 2 to FIG. 4 may be referred to for the process of determining the second delivery person, the details of which are not repeatedly described herein for the sake of conciseness.

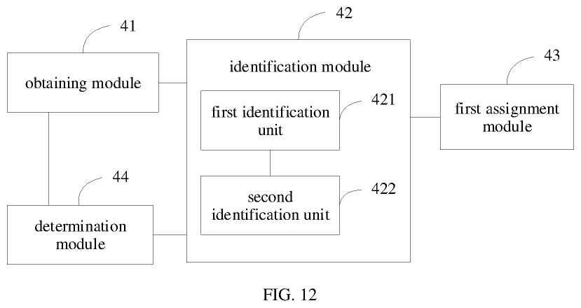

FIG. 12 is a schematic structural diagram of Embodiment 5 of an order assignment apparatus according to the embodiments of this disclosure. As shown in FIG. 12, the apparatus may include an obtaining module 41, an identification module 42, and a first assignment module 43.

The obtaining module 41 may be configured to obtain a to-be-assigned order.

The identification module 42 may be configured to determine whether the order is a recallable order.

The first assignment module 43 may be configured to associate the order with a recallable attribute, and assign the order to a first delivery person if the order is determined to be a recallable order by the identification module.

In some embodiments, the identification module 42 may include a first identification unit 421.

The first identification unit 421 may be configured to determine that the order is a recallable order if attribute information of the order meets a preset recall attribute requirement.

The attribute information may include at least one of: a user level corresponding to the order, a delivery area corresponding to the order, a service source corresponding to the order, or an expected arrival time corresponding to the order.

In some embodiments, the apparatus may further include a determination module 44.

The determination module 44 may be configured to determine the first delivery person corresponding to the order.

The identification module 42 may include a second identification unit 422.

The second identification unit 422 may be configured to estimate a delivery efficiency indicator corresponding to a delivery of the order performed by the first delivery person; and determine that the order is a recallable order if the delivery efficiency indicator is higher than a preset delivery efficiency indicator threshold.

The apparatus shown in FIG. 12 can perform the method in the embodiment shown in FIG. 10. Related description in the embodiment shown in FIG. 10 may be referred to for the part not described in detail in this embodiment, and for the implementation process and technical effects of the technical solution, the details of which are not repeatedly described herein for the sake of conciseness.

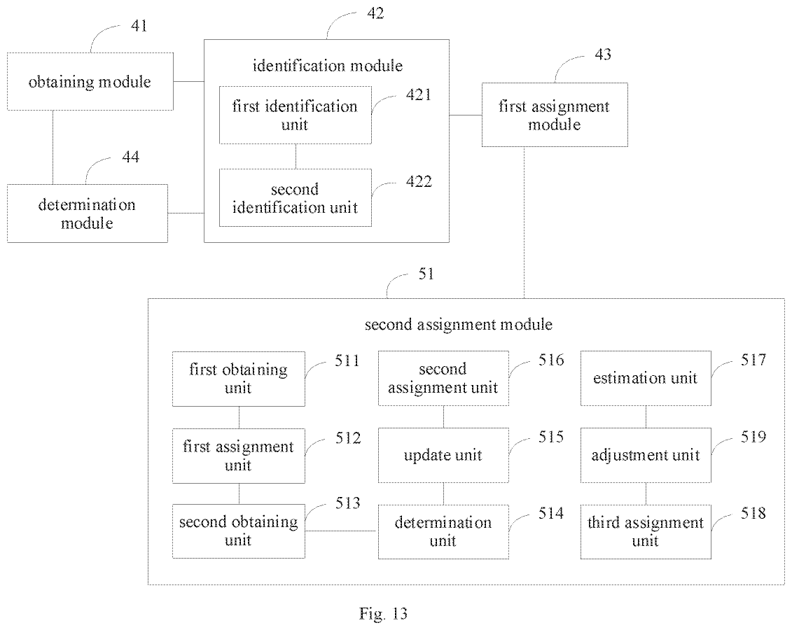

FIG. 13 is a schematic structural diagram of Embodiment 6 of an order assignment apparatus according to the embodiments of this disclosure. As shown in FIG. 13, on the basis of the embodiment shown in FIG. 12, the apparatus may further include a second assignment module 51.

The second assignment module 51 may be configured to reassign the order to a corresponding second delivery person if a recall request for the order is received from the first delivery person.

In some embodiments, the second assignment module 51 may be further configured to: if the order has been recalled N times, associate the order with a non-recallable attribute, and assign the order to an (N+1)^{th} delivery person. N is a maximum recall number, and is greater than or equal to 1.

In some embodiments, the second assignment module may include: a first obtaining unit 511, a first assignment unit 512, a second obtaining unit 513, a determination unit 514, an update unit 515, and a second assignment unit 516.

The first obtaining unit 511 may be configured to obtain at least one candidate delivery person based on a delivery address of the order.

The first assignment unit 512 may be configured to designate, if a delivery person selected from the at least one candidate delivery person through an order combining mechanism can accept the order and is different from the first delivery person, the selected delivery person as the second delivery person.

The second obtaining unit 513 may be configured to obtain, if no second delivery person is selected through the order combining mechanism by the first assignment unit 512, an order group that includes the order.

The determination unit 514 may be configured to determine a matching degree between the order group and each of the at least one candidate delivery person.

The update unit 515 may be configured to update the matching degree by reducing a corresponding matching degree between the order group and the first delivery person if the at least one candidate delivery person includes the first delivery person.

The second assignment unit 516 may be configured to assign the order group to a corresponding second delivery person based on the updated matching degree.

In some embodiments, the recall request may include a recall reason, and the second assignment module 51 may include: an estimation unit 517, a third assignment unit 518, and an adjustment unit 519.

The estimation unit 517 may be configured to re-estimate a shipping time and/or an expected arrival time of the order if the recall reason indicates a long shipping delay.

The adjustment unit 519 may be configured to extend the shipping time if an interval between the shipping time and a current time is less than a preset threshold, and/or to extend the expected arrival time if an interval between the expected arrival time and the current time is less than the preset threshold.

The third assignment unit 518 may be configured to reassign the order to a corresponding second delivery person based on the re-estimated shipping time and/or the re-estimated expected arrival time.

The apparatus shown in FIG. 13 can perform the method in the embodiment shown in FIG. 11. Related description in the embodiment shown in FIG. 11. May be referred to for the part not described in detail in this embodiment, and for the implementation process and technical effects of the technical solution, details of which are not repeatedly described herein for the sake of conciseness.

The apparatus embodiments described above are merely examples. The units described as discrete parts may be physically separated or not, and parts displayed as units may be physical units or not, may be located in one place or distributed on a plurality of network units. Some or all of the modules may be selected according to actual needs to achieve the objectives of the solution of this embodiment. A person of ordinary skill in the art can understand and implement the solution without creative efforts.

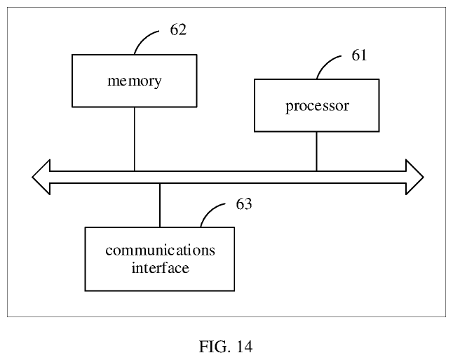

The internal functions and structure of the order assignment apparatus have been described above. This disclosure further provides an electronic device. The electronic device may be a server. As shown in FIG. 14, the electronic device may include a processor 61 and a memory 62. The memory 62 may be configured to store a program that enables the electronic device to perform the order assignment method according to any of the foregoing embodiments, and the processor 61 may be configured to execute the program stored in the memory 62.

The program may include one or more computer instructions. Upon being executed by the processor 61, the one or more computer instructions may perform the following steps: obtaining a to-be-assigned order; determining whether the order is a recallable order, and, if the order is determined to be a recallable order, associating the order with a recallable attribute and assigning the order to a first delivery person.

In some embodiments, the processor 61 may be further configured to perform all or some of the steps in the foregoing method embodiments.

The structure of the electronic device may further include a communications interface 63 for the electronic device to communicate with other devices or communications networks.

This disclosure further provides a computer-readable storage medium. The computer-readable storage medium may be configured to store a computer software instruction and may include a program for performing the order assignment methods described in the embodiments shown in FIG. 10 and FIG. 11.

Through the description of the foregoing embodiments, a person skilled in the art may clearly understand that all the embodiments may be implemented by using software in combination with a necessary universal hardware platform, or by using a combination of hardware and software. Based on such an understanding, the foregoing technical solutions essentially or the part contributing to the prior art may be implemented in a form of a computer product. The computer program product in this disclosure may be implemented by one or more computer-accessible storage media (including but not limited to a magnetic disk memory, a CD-ROM, or an optical memory) that include computer-accessible program code.

This disclosure is described with reference to the flowcharts and/or block diagrams of the method, the device (system), and the computer program product according to the embodiments of this disclosure. It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more central processing units (CPUs), an input/output interface, a network interface, and a memory.

The memory may include a non-persistent memory, a random access memory (RAM), and/or a non-volatile memory, or other forms of computer-readable media, such as a read-only memory (ROM) or a flash memory (flash RAM). The memories are merely examples of the computer-readable media.

The computer-readable media include persistent, non-persistent, removable, and non-removable media, in which information may be stored by using any method or technology. The information may be computer-readable instructions, data structures, program modules, or other data. Examples of the computer storage media include, but are not limited to, a phase change memory (PRAM), a static RAM (SRAM), a dynamic RAM (DRAM), other types of RAMs, a ROM, an electrically erasable programmable ROM (EEPROM), a flash memory or other memory technologies, a compact disk ROM (CD-ROM), a digital versatile disk (DVD) or other optical storages, a cassette tape, magnetic tape or disk storage, or other magnetic storage devices, or any other non-transmission media, which can be used to store information accessible to a computing device. As defined herein, the computer-readable media do not include computer-readable transitory media, such as modulated data signals and carriers.

Finally, it should be noted that the foregoing embodiments are merely intended for describing but not limiting the technical solutions of this disclosure. Although this disclosure is described in detail with reference to the foregoing embodiments, a person of ordinary skill in the art should understand that they may still make modifications to the technical solutions described in the foregoing embodiments or make equivalent replacements to some technical features thereof, and such modifications and replacements do not cause the essence of the corresponding technical solutions to depart from the spirit or scope of the technical solutions of the embodiments of this disclosure.

What is claimed is:

1. An order assignment method, performable by a server, comprising:
determining a first delivery person corresponding to an order;
estimating a delivery efficiency indicator corresponding to a delivery of the order performed by the first delivery person; and
in response to the delivery efficiency indicator being higher than a preset delivery efficiency indicator threshold, associating the order with a recallable attribute, and assigning the order to the first delivery person.

2. The method of claim 1, further comprising:
reassigning, in response to a recall request for the order received from the first delivery person, the order to a corresponding second delivery person.

3. The method of claim 2, wherein reassigning the order to a second delivery person comprises:
obtaining, based on a delivery address of the order, at least one candidate delivery person; and
designating, in response to a delivery person selected from the at least one candidate delivery person through an order combining mechanism can accept the order and is different from the first delivery person, the selected delivery person as the second delivery person.

4. The method of claim 3, further comprising:
obtaining, in response to no second delivery person being selected through the order combining mechanism, an order group that comprises the order;
determining a matching degree between the order group and each of the at least one candidate delivery person;
updating the matching degree by reducing a corresponding matching degree between the order group and the first delivery person if the at least one candidate delivery person includes the first delivery person; and
assigning, based on the updated matching degree, the order group to a corresponding second delivery person.

5. The method of claim 2, wherein the recall request comprises a recall reason, and wherein reassigning the order to a corresponding second delivery person comprises:
re-estimating, in response to the recall reason indicating a long shipping delay, the shipping time and an expected arrival time of the order; and
reassigning, based on the re-estimated shipping time and the re-estimated expected arrival time, the order to a corresponding second delivery person.

6. The method of claim 5, further comprising: after re-estimating the shipping time and an expected arrival time of the order,
extending, in response to an interval between the shipping time and a current time being less than a preset threshold, the shipping time; and
extending, in response to an interval between the expected arrival time and the current time being less than the preset threshold, the expected arrival time.

7. The method of claim 2, wherein the recall request comprises a recall reason, and wherein reassigning the order to a corresponding second delivery person comprises:
re-estimating, in response to the recall reason indicating a long shipping delay, the shipping time of the order; and
reassigning, based on the re-estimated shipping time, the order to a corresponding second delivery person.

8. The method of claim 7, further comprising: after re-estimating a shipping time of the order,
extending, in response to an interval between the shipping time and a current time being less than a preset threshold, the shipping time.

9. The method of claim 2, wherein the recall request comprises a recall reason, and wherein reassigning the order to a corresponding second delivery person comprises:
re-estimating, in response to the recall reason indicating a long shipping delay, an expected arrival time of the order; and
reassigning, based on the re-estimated expected arrival time, the order to a corresponding second delivery person.

10. The method of claim 9, further comprising: after re-estimating an expected arrival time of the order,
extending, in response to an interval between the expected arrival time and a current time being less than a preset threshold, the expected arrival time.

11. The method of claim 2, further comprising:
in response to the order having being recalled N times, associating the order with a non-recallable attribute, and assigning the order to an (N+1)^{th} delivery person, wherein N is a maximum recall number, and is greater than or equal to 1.

12. An order assignment apparatus, comprising:
a determination module, configured to determine a first delivery person corresponding to an order;
an estimation module, configured to estimate a delivery efficiency indicator corresponding to a delivery of the order performed by the first delivery person; and
a first assignment module, configured to, in response to the delivery efficiency indicator being higher than a preset delivery efficiency indicator threshold, associate the order with a recallable attribute, and assign the order to the first delivery person.

13. The apparatus of claim 12, further comprising:
a second assignment module, configured to reassign, in response to a recall request for the order received from the first delivery person, the order to a corresponding second delivery person.

14. The apparatus of claim 13, wherein the second assignment module comprises:
a first obtaining unit, configured to obtain, based on a delivery address of the order, at least one candidate delivery person; and
a first assignment unit, configured to designate, in response to a delivery person selected from the at least one candidate delivery person through an order combining mechanism can accept the order and is different from the first delivery person, the selected delivery person as the second delivery person.

15. The apparatus of claim 14, wherein the second assignment module further comprises:
a second obtaining unit, configured to obtain, in response to no second delivery person being selected through the order combining mechanism, an order group that comprises the order;
a determination unit, configured to determine a matching degree between the order group and each of the at least one candidate delivery person;
an update unit, configured to update the matching degree by reducing a corresponding matching degree between the order group and the first delivery person if the at least one candidate delivery person includes the first delivery person; and
a second assignment unit, configured to assign, based on the updated matching degree, the order group to a corresponding second delivery person.

16. The apparatus of claim 13, wherein the recall request comprises a recall reason, and wherein the second assignment module further comprises:
an estimation unit, configured to re-estimate, in response to the recall reason indicating a long shipping delay, the shipping time and an expected arrival time of the order; and
a third assignment unit, configured to reassign, based on the re-estimated shipping time and the re-estimated expected arrival time, the order to a corresponding second delivery person.

17. The apparatus of claim 16, wherein the second assignment module further comprises:
an adjustment unit, configured to extend, in response to an interval between the shipping time and a current time being less than a preset threshold, the shipping time, and to extend, in response to an interval between the expected arrival time and the current time being less than the preset threshold, the expected arrival time.

18. The apparatus of claim 13, wherein the recall request comprises a recall reason, and wherein the second assignment module further comprises:
an estimation unit, configured to re-estimate, in response to the recall reason indicating a long shipping delay, the shipping time of the order; and
a third assignment unit, configured to reassign, based on the re-estimated shipping time, the order to a corresponding second delivery person.

19. The apparatus of claim 18, wherein the second assignment module further comprises:
an adjustment unit, configured to extend, in response to an interval between the shipping time and a current time being less than a preset threshold, the shipping time.

20. The apparatus of claim 13, wherein the recall request comprises a recall reason, and wherein the second assignment module further comprises:
an estimation unit, configured to re-estimate, in response to the recall reason indicating a long shipping delay, an expected arrival time of the order; and
a third assignment unit, configured to reassign, based on the re-estimated expected arrival time, the order to a corresponding second delivery person.

21. The apparatus of claim 20, wherein the second assignment module further comprises:
an adjustment unit, configured to extend, in response to an interval between the expected arrival time and a current time being less than a preset threshold, the expected arrival time.

22. The apparatus of claim 13, wherein the second assignment module is further configured to:
in response to the order having been recalled N times, associate the order with a non-recallable attribute, and assign the order to an (N+1)^{th} delivery person, wherein N is a maximum recall number, and is greater than or equal to 1.

23. An electronic device, comprising a memory and a processor, wherein the memory is configured to store one or more computer instructions, and upon being executed by the processor, the one or more computer instructions perform an order assignment method comprising:
determining a first delivery person corresponding to an order;
estimating a delivery efficiency indicator corresponding to a delivery of the order performed by the first delivery person; and
in response to the delivery efficiency indicator being higher than a preset delivery efficiency indicator threshold, associating the order with a recallable attribute, and assigning the order to the first delivery person.
